(19) United States
(12) Patent Application Publication
(10) Pub. No.: US 2011/0005642 A1
(43) Pub. Date: Jan. 13, 2011

(54) Method for Making Braided Structures

(76) Inventor: Vitaly Vasilyevich Merezhkin, Krasnodar Krai (RU)

Correspondence Address: Merezhkin, Vitaly Vasilyevich, Patentica, Box 1125, Saint Petersburg, 190000, RU

(21) Appl. No.: 12/308,588

(22) PCT Filed: Jul. 2, 2007
(86) PCT No.: PCT/RU2007/000356

§ 371 Date: Sep. 8, 2010

(30) Foreign Application Priority Data
Jul. 5, 2006 (RU) 2006124163

(51) Int. Cl. B27M 1/08; B27G 11/00

(52) U.S. Cl. 144/350; 144/344

(57) ABSTRACT

A method for making wicker constructions is proposed, which can be used for interior decoration of buildings as heating radiators screens, light-weight partitions, wall and ceiling panels, furniture elements and door-panels. The method allows decreasing efforts for making the wickering and increasing rigidness and carrying capacity of wicker constructions. The wickered elements are placed into the construction along two, predominantly mutually perpendicular directions. The first direction elements are pre-produced as straps with straight profile or corrugated profile with a step L, the second direction elements are pre-produced as straps with corrugated profile with a step L. The first elements are placed in parallel rows with an interval L/2. The first elements crossing the second elements are placed into their depressions. The corrugated elements can be pre-produced of corrugated plywood, corrugated wooden veneer sheets, a wooden billet milled to a corrugated profile, and then the corrugated materials are sawn into straps.

The invention is referred to the wood processing industry and construction and meant for producing wicker constructions which can be used later in interior decoration of buildings as screens of heating radiators, light partitions, wall and ceiling panels and also as elements of furniture and door panels.

Numerous constructions are known which are made in a traditional way of wickering, for example wicker furniture [1]. The method of making such wicker constructions is that elements of construction made as wickers, ribbons or straps wicker among themselves with that the elements are placed into the construction as minimum along two directions and connect elements of the construction among themselves so that each of them goes through by turns on top and down the others at right angle or oblique angle for all that the elements of construction acquire corrugated profile. As raw materials for elements of construction one can use wickers of different types of wood, bamboo and also synthetic materials.

Because for making wicker construction which have extra toughness and carrying ability one should use elements of more thickness and/or toughness. Applying this method leads by wickering to the necessity of significant physical efforts. It happens because the efforts by wickering are directed to bending the elements of construction to small radiuses of curvature to have corrugated profile which is necessary for making wickering and this is a disadvantage of that method. Besides, another one disadvantage of the described method is that elements used in this construction must have extra flexibility which limits the spectrum of suitable materials for wickering.

There are some constructive wicker webs of wooden materials for example rattan webbing. The method of making such wicker constructions is that elements of construction as thin ribbons of wooden material wicker among themselves mainly in a motorized way which allows to simplify the technology of furniture making and other products with wicker elements [2].

The disadvantage of making rattan webbing is that wicker construction made in this way has extremely low carrying ability and that is why always has decorative function after their fixation on firm frame.

There are also constructions made by the method of wickering of wooden veneer sheet for example partitions, blind, ventilation grids, heating radiator grids that have protective along with decorative functions [3].

The method of making such wicker constructions on the basis of essential traits is the nearest analogue to the declared method of making wicker constructions. The method is that elements of construction are wickered among themselves for all that the elements are placed into the construction along the two, predominantly mutually perpendicular directions. Besides that, as elements of the construction one can use straps. Besides that the straps are made of wooden veneer sheet [4].

The wooden veneer sheet is the material received by motorized way. The sheets of wooden veneer have stable size in thickness and can easily be sawed along fibers into the straps of equal width suitable for wickering. But because one should apply efforts to the elements of construction when wicker directed onto the curve deformation to small radiuses of curvature to acquire corrugated profile necessary for making wickering, some negative qualities of wood as materials for wickering arise. Apart from other materials used when making wicker constructions, wood has more toughness and non-sufficient flexibility. The flexibility of the material is realized at action of the forces directed at the curve deformation. For all that the main attribute determining the quantity of acting force necessary for the material curve is the modulus of elasticity E. For example the modulus of elasticity E for beech curve is E≈12 GPa and for willow rod traditionally used at making wicker products the elasticity modulus is E≈1 GPa. For the element of wicker construction made of wood as well as for all hard materials within limit of elastic deformations according to Guk Law, the elasticity modulus E is:

E=F/A·e

F—the force applied at the element of the wicker construction;

A—the square of cross-section of the element;

e—relative deformation in the element.

In this way by wickering the quantity of effort directed at the element curve deformation of the construction is proportional to the elasticity modulus of the material of the element; its thickness and the quantity of its relative deformation arising at curve, which becomes more if the radius of curvature becomes less.

Due to this reason to wicker by described method is possible only given the small thickness of the straps of the wooden veneer sheet as for the curve of the straps of more thickness up to small radiuses of curvature one needs extremely big physical efforts directed at acquiring corrugated profile which is necessary for making wickering. Besides that when growing the thickness of curving straps of wooden veneer sheet, the minimal accessible radius of curvature r in a corrugated profile grows too, because:

r=h/2e (c1)

e—permissible relative deformation of stretching along fibers;

h—thickness of straps.

Fulfilling the condition (c1) allows to make a strap curve without its destroying (breaking the fibers) [5].

In this way, the disadvantage of described method of making wicker constructions is that during the process when using straps of bigger thickness as elements of construction, for example for making wicker constructions that have extra toughness and carrying ability, one should apply significant physical efforts. Besides, the minimal radius of curvature arising in elements of construction by wickering is limited with the condition (c1) which is also the disadvantage of the described method.

To remove the disadvantage of the described method is possible by reducing deformations arising in elements of construction at wickering.

The technical result ensured with this invention is reducing efforts necessary for making wickering.

An extra technical result ensured with this invention is increasing toughness and carrying ability of the wicker constructions.

The essence of the declared method of making wicker constructions is that the elements of construction are wickered among themselves for all that the elements are placed into construction along two, predominantly mutually perpendicular directions. Besides, as elements of construction placed by wickering as minimum along one direction are used straps with corrugated profile moreover, the elements of construction crossing the straps with corrugated profile are placed into depressions of these straps.

One can use straps with corrugated profile as all elements of construction by wickering.

One can make straps with corrugated profile of corrugated plywood for all that the plywood is sawed into straps.

One can make straps with corrugated profile of wooden veneer sheets for all that the sheets of wooden veneer are bended and simultaneously glued together into corrugated wooden material and then are sawed into straps.

One can make straps with corrugated profile of wood for all that the wooden billet is milled to give it the corrugated profile and then is sawed into straps.

The technical result is: decreasing efforts necessary for making wickering achieves on account of the fact that in the declared method of making wicker constructions one uses straps with corrugated profile as elements of construction placed by wickering as minimum along one direction. Besides that, the elements of construction crossing the straps with corrugated profile are placed into depressions of these straps. It allows not to bend the elements of wicker construction up to small radiuses of curvature to give them the corrugated profile necessary for making wickering. In this way the efforts directed at the elements deformation and making wickering are decreased.

The technical result increasing the toughness and carrying ability of wicker constructions is achieved on account of the fact that in the declared method of making wicker constructions one uses straps with corrugated profile as elements of construction placed by wickering as minimum along one direction. Besides that, the elements of construction crossing the straps with corrugated profile are placed into depressions of these straps. It allows not to bend the elements of wicker construction up to small radiuses of curvature to give them the corrugated profile necessary for making wickering. Therefore, for all that critical deformations do not arise in the elements of construction which can cause to their destruction. In this way the elasticity of elements of the construction in the declared method of making wicker constructions does not become critical by wickering and the opportunity arises to use elements with the thickness that significantly exceeds the thickness of the elements which are used in the well-known methods of making wicker constructions.

The essence of the invention is explained with the following graphic materials:

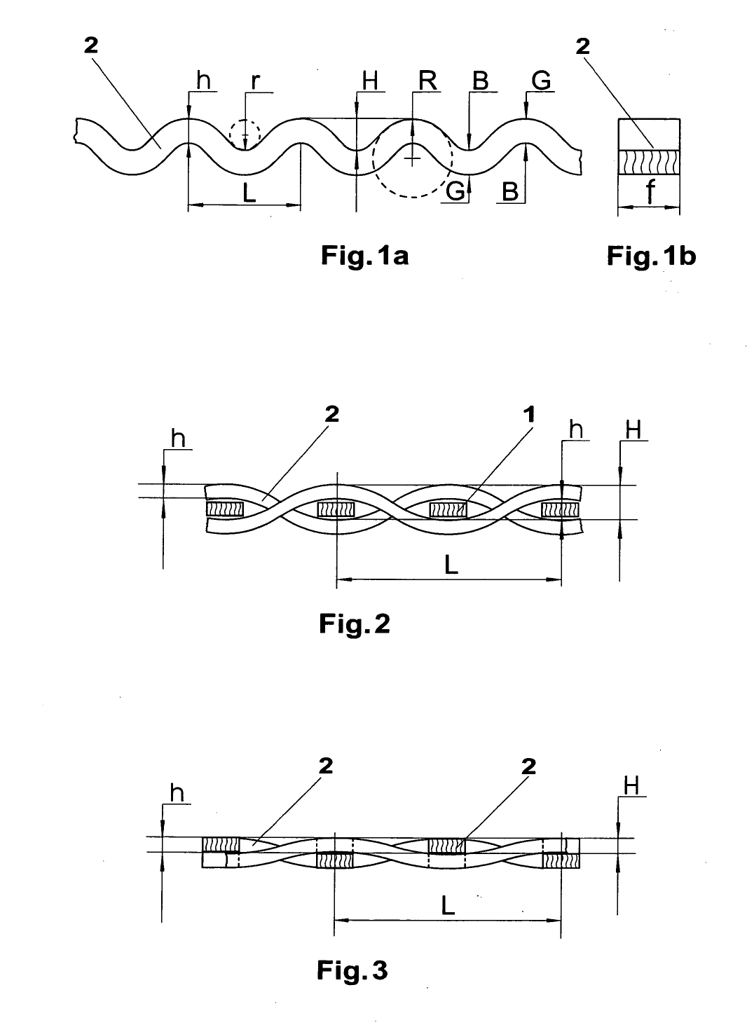

FIG. 1.—parameters of the strap with corrugated profile.

FIG. 2.—fragment of the wicker construction made of straps of wooden veneer sheet with straight and corrugated profile in section and the parameters of its elements.

FIG. 3.—fragment of the wicker construction made of straps of wooden veneer sheet with corrugated profile in section and parameters of its elements.

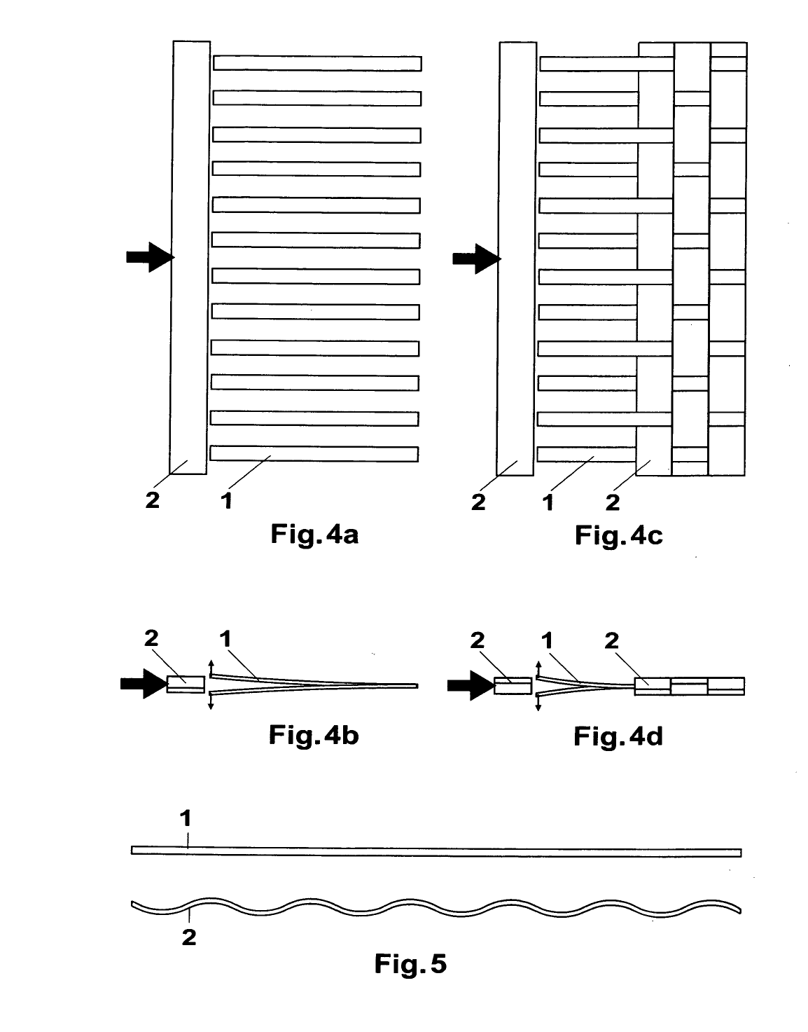

FIG. 4.—the scheme of making wicker construction according to example 1 and example 3, view from above and side view.

FIG. 5.—profile of the straps used in examples 1 and 3 as elements of construction.

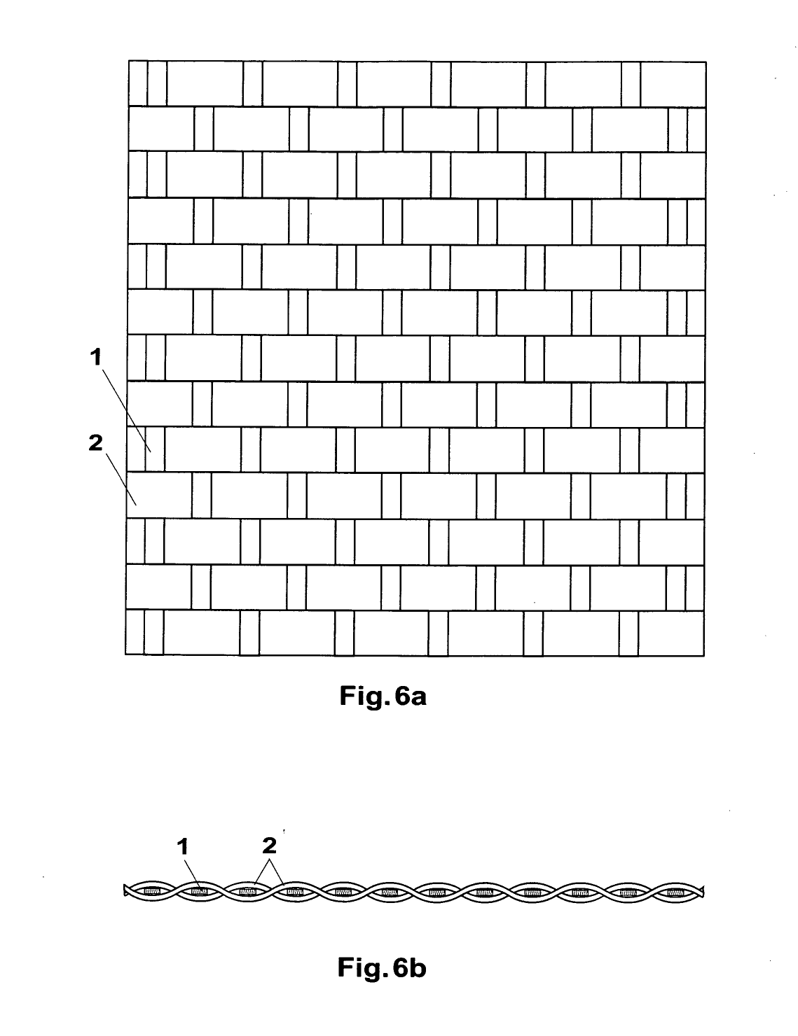

FIG. 6.—general view of wicker construction as in example 1 and 3, view from above and side view.

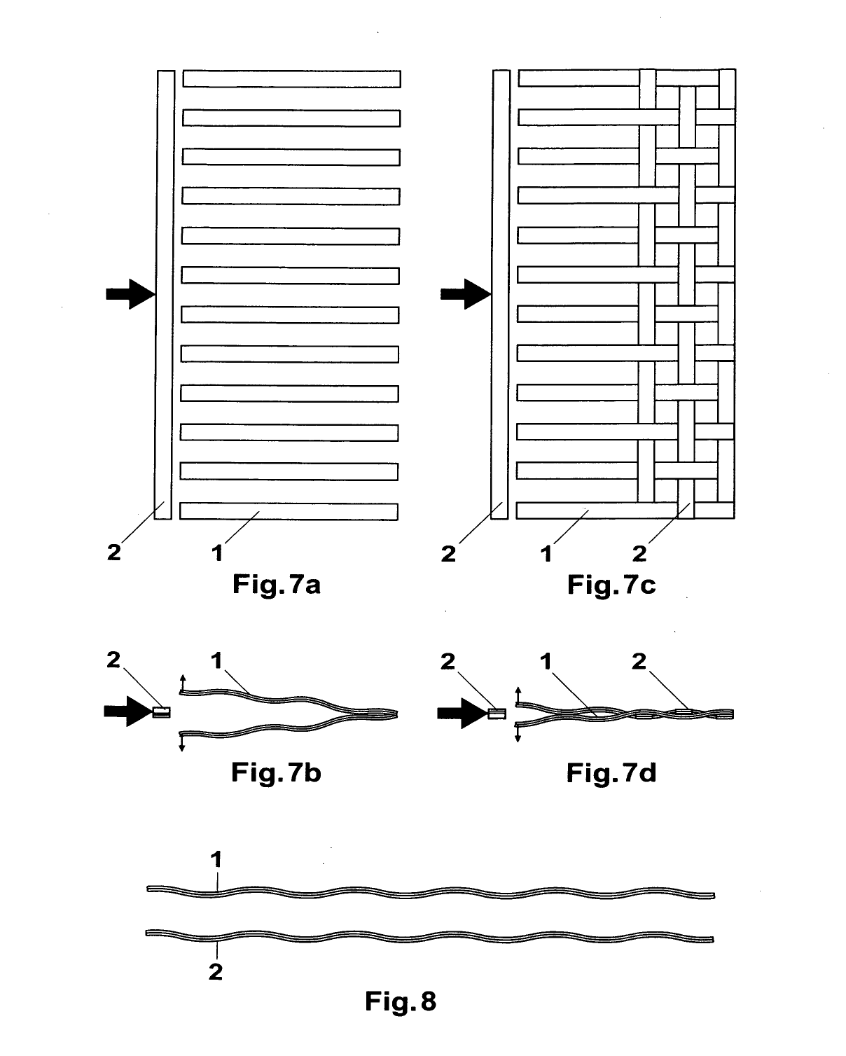

FIG. 7.—the scheme of making wicker construction as in example 2, view from above and side view.

FIG. 8.—profile of the straps used in example 2 as elements of construction.

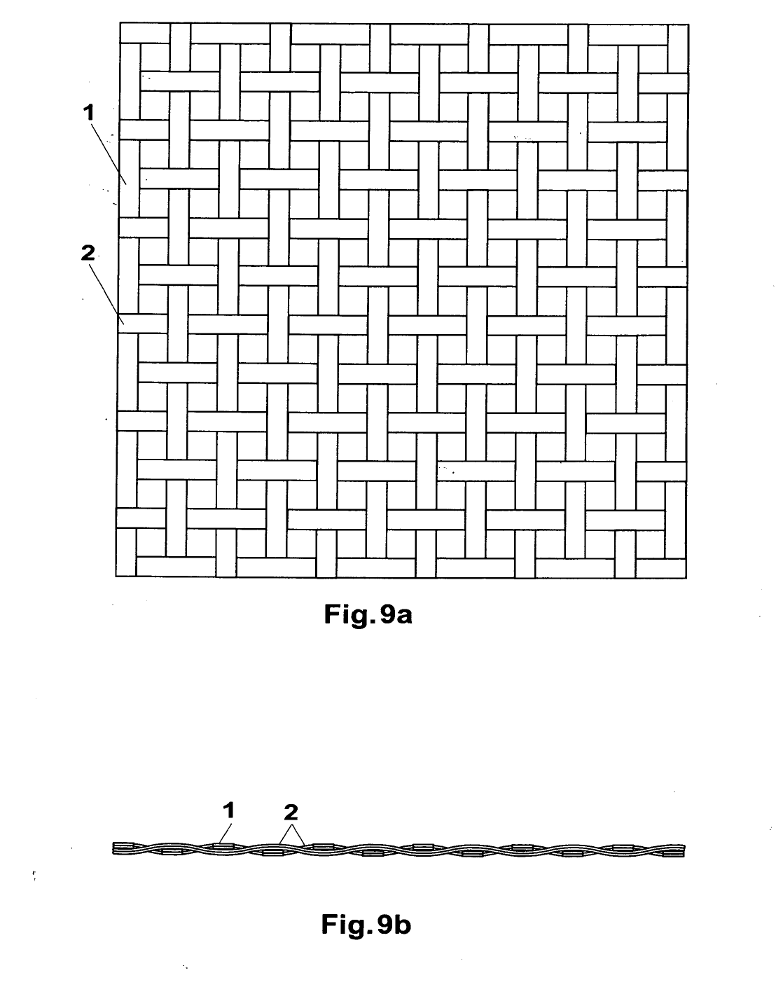

FIG. 9.—general view of wicker construction as in example 2, view from above and side view.

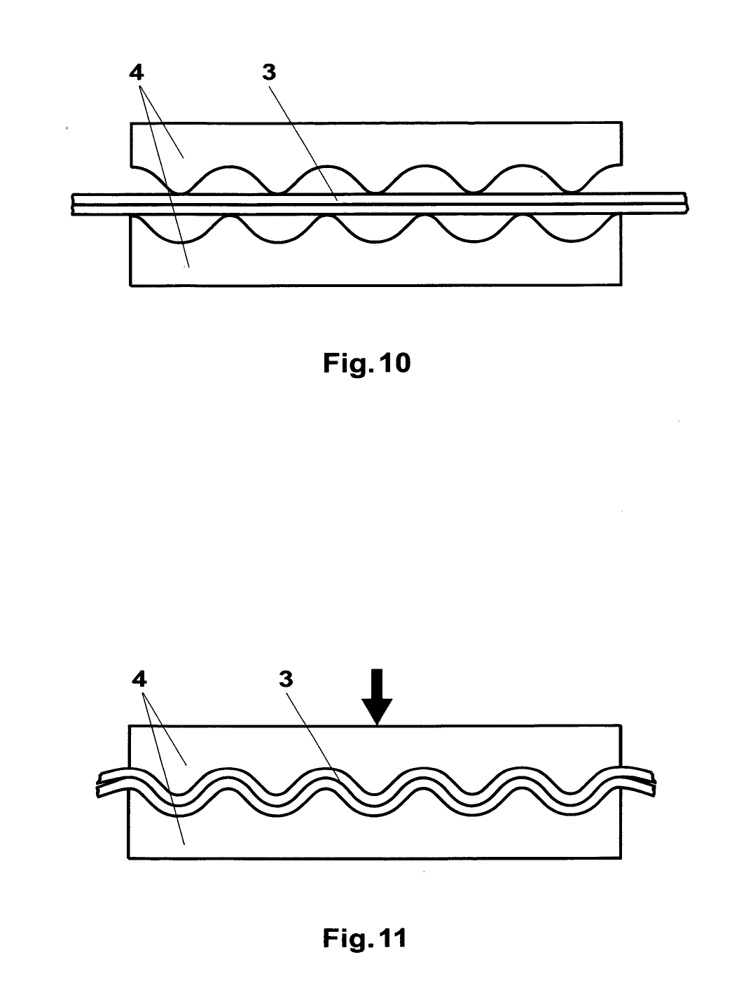

FIG. 10.—scheme of making corrugated wooden material of veneer sheet by bending with simultaneous glueing together: placing the package of wooden veneer sheets into pressing-mould machine.

FIG. 11.—scheme of making corrugated wooden material of wooden veneer sheet by bending with simultaneous glueing together: pressing.

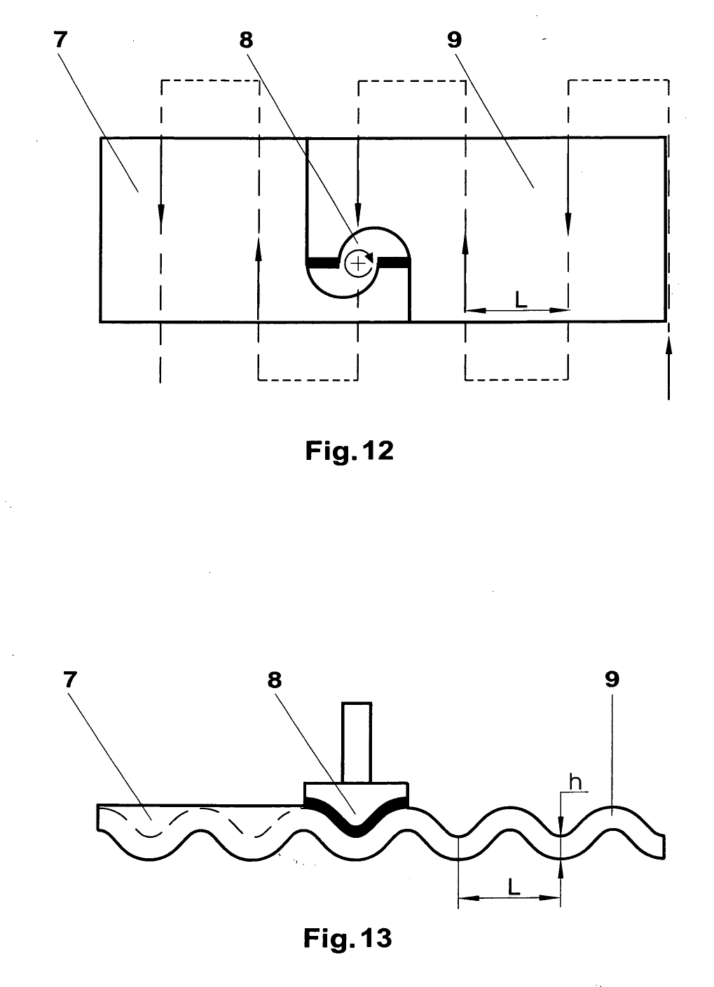

FIG. 12.—scheme of making wooden billet with corrugated profile by milling, from above view.

FIG. 13.—scheme of making wooden billet with corrugated profile by milling, side-view.

It is suggested in the declared method of making wicker constructions to use straps with corrugated profile as elements placed as minimum along one direction and to place elements of construction crossing the straps with corrugated profile in the depressions of these straps. The corrugated profile is shaped so that it practically does not differ outwardly from the profile which straight elements acquire in the process of wickering with one another in the well-known methods of making wicker constructions [4] and is determined with several parameters:

It is shown in FIG. 1: (2)—element of construction as a strap with corrugated profile. L—step of alternating of corrugation, h—strap thickness, f—strap width, H—corrugation height, r—minimal radius of strap curvature, R—maximal of strap curvature. B—depressions of corrugated profile. Γ—humps of corrugated profile.

The step of alternating of corrugation L determines the minimal distance between the elements crossing the straps with corrugated profile in wicker construction. The thickness of strap h as well as its width f determines its toughness. The height of corrugation H correlates to the depression B. The height of corrugation H is assigned when shaping the strap with corrugated profile taking into account thickness, width and the shape of the profile of construction elements which will cross the straps with corrugated profile by wickering. For all that, the quantity H is chosen so that elements of construction wouldn't feel bending moments from the straps with corrugated profile after producing the construction. For example: In FIG. 2 is shown the fragment section of wicker construction made according to the declared method of the elements of equal thickness h, made as straps with corrugated profile (2) and straps with straight profile (1) which cross straps (2), for all that the height of corrugation H≈2h. In FIG. 3 is shown the fragment in section of wicker construction made according to the declared method in which all the elements (2) are the straps with corrugated profile and have the thickness h, for all that the height of corrugation is H≈h.

The minimal curvature radius of the strap r limited with condition (c1) is taken into consideration by shaping the strap of corrugated profile by the method of bending and simultaneous glueing together [6]. For all that the minimal radius of curvature r determines the permissible correlations between quantity L and H in corrugated profile because taken into account the geometrical correlations in corrugated profile of a strap the approximate equation takes place:

r≈L²/16H

Maximal curvature radius of the R corresponds to chosen parameters L, h and H and has no limits.

The declared method of making wicker constructions is done as follows. The elements of construction as wickers, straps, bands with straight profile or straps with corrugated profile are placed in a row horizontally and parallel with each other with the step L/2 along the first direction. Then the wickering is made, for that the ends are bended in turns upwards and downwards from one side and the element as the strap with corrugated profile with the step L is fitted among them horizontally. For all that it is placed along the second direction, predominantly which is perpendicular to the first one. Then it is moved up to the other side of elements which are placed along the first direction, moreover the elements of construction crossing the straps with corrugated profile are placed into the depressions of these straps by wickering. Then the ends of the elements placed along the first direction are bended into opposite direction and analogously is placed next element as strap with corrugated profile oriented along the second direction and then the cycle is repeated.

In this way, when making the wicker construction by the declared method, the elements of construction are wickered among themselves and one uses straps with corrugated profile as elements of construction placed by wickering as minimum along one direction For all that the elements of construction crossing the straps with corrugated profile are placed into depressions of these straps. It allows not to bend the elements of construction up to small curvature radiuses and correspondingly not to apply efforts directed at giving the elements of construction the corrugated profile which is necessary for making wickering.

In this way the technical result is ensured: decreasing efforts necessary for making wickering. Besides, there is no deformation in elements that can lead to its destruction and it allows to make the construction with extra toughness and carrying ability of the elements with big thickness. In this way the technical result is ensured: increasing the toughness and carrying ability of wicker constructions.

### EXAMPLES OF CONCRETE CARRYING-OUT

### Example 1

In FIG. 4 it is shown the scheme of making wicker construction according to the declared method in which the construction is made of the following elements:

(1)—elements placing along the first direction as straps with straight profile made of wood. (2)—elements placing along the second direction as straps with corrugated profile made of corrugated plywood.

Making the wicker construction is carried out as follows: straps (1) are produced on standard wood-processing equipment of wood with straight profile of thickness 5 mm, width 12 mm and length determined by the size of construction. The sheets of corrugated plywood [7] of thickness 5 mm, height of corrugation 11 mm and step of alternating corrugation 75 mm are sawed crosswise the corrugation on multisawing-dividing machine (TDK-5 ( [symbol] K-5)) into straps (2) with corrugated profile of width 30 mm. Elements (1) as straps with straight profile in quantity determined by size of construction are placed into a row horizontal and parallel with one another with the step of 37.5 mm along the first direction. Then, in turns one bends the ends of elements (1) upwards and downwards from one side and fits among them horizontally element (2) as a strap with corrugated profile. For all that it is placed along the second direction, perpendicular to the elements (1) so that its depressions were opposite the elements (1). Then one moves up the element (2) to the other side of elements (1). Then one bends the ends of elements (1) in the opposite direction and analogously are placed the next element (2) as a strap with corrugated profile and than the cycle is repeated. One continues the assembling analogously correspondingly to the length of elements (1).

In FIG. 5 it is shown the profile of straps (1) and (2) used in the described example as elements of construction.

In FIG. 6 it is shown the general view of the produce wicker construction.

### Example 2

In FIG. 7 it is shown the scheme of the model of making wicker construction according to the declared method in which the construction is made up of the following elements: (1)—elements placed along the first direction as straps with corrugated profile made of wooden veneer sheet. (2)—elements placed along the second direction as straps with corrugated profile made of wooden veneer sheet.

The process of making wicker construction is as follows: the package (3) composed of five sheets of wooden veneer of thickness 1 mm with applied glue is pressed in the pressing-mould machine (4) (FIG. 10 and FIG. 11) using the method of bending with simultaneous glueing together [6] for all that one gets the corrugated wooden material of thickness 5 mm, corrugation height 6 mm, step of alternating corrugation 75 mm. The corrugated wooden material is sawed crosswise corrugation at the multisawing dividing machine (TDK-5 ( [symbol] K-5)) into the straps with corrugated profile of width 15 mm and length determined by the size of construction for all that we get elements (1) and (2). Elements (1) as straps with corrugated profile in quantity determined by the size of construction are placed into a row, horizontally and parallel with each other with a step of 37.5 mm along the first direction moving them so that the humps of the neighbouring elements (1) were adjoiningly to their depressions (FIG. 7). Then in turns one bends the ends of elements (1) upwards and downwards from one side and fits among them horizontally the element (2) as a strap of with corrugated profile. For all that it is placed along the second direction perpendicular to elements (1) so that its depressions were opposite to the elements (1). Then one moves up element (2) to the other side of elements (1) and it is placed into depressions of elements (1). Then the ends of elements (1) are bended into opposite directions and analogously is placed the next element (2) as a strap with corrugated profile and then the cycle is repeated. The assembling is continued according to the length of the elements (1).

In FIG. 8 it is shown the profile of straps (1) and (2) used in the given example as elements of construction.

In FIG. 9 it is shown the general view of the wicker construction.

### Example 3

In FIG. 4 it is shown the scheme of the example of making wicker construction on the declared method in which the construction is made of the following elements. (1)—elements placed along the first direction as straps with straight profile made of wood. (2)—elements placed along the second direction as straps with corrugated profile made of wood.

The making the wicker construction is as follows: straps (1) with straight profile are made on standard wood-processing equipment with thickness 5 mm, width 12 mm and length determined by the size of construction. The wooden billet (7) acquires the corrugated profile by milling (FIG. 12 and FIG. 13). For that purpose the billet (7) as a plank of thickness 16 mm is placed with plate downwards and fix it on a working desk (not shown) of the milling machine (VFK-1 (BφK-1)). Then one lowers down the end mill (8) of diameter 75 mm at height of 5 mm from the surface of the working desk (not shown) and places it opposite the long side of the billet at its edge. One activates on the power of the mill (not shown) and starts moving the billet (7) relatively the end mill (8) on the trajectory which is marked with dotted line. Rotating and moving according to the trajectory relatively the billet, the end mill (8) cuts the part of the billet material (7) and shapes on it the waving profile (9) with the shape corresponding to the mill profile and with a step of L=75 mm which corresponds to the trajectory of mill movement. After one side processing, the billet (7) is turned over, moved along its long side at distance L/2 and processed its second side analogously with the first one for all that the billet acquires the corrugated profile with corrugation height H=11 mm and thickness h=5 mm. Then the billet is sawed crosswise the corrugation on multi-sawing dividing machine (TDK-5 ( [symbol] K-5)) into straps (2) with corrugated profile of width f=30 mm. Elements (1) as straps with straight profile in quantity determined by the size of construction are placed in a row horizontally and parallel with each other with a step of 37.5 mm along the first direction (FIG. 4). Then in turns one bends the ends of the elements (1) upwards and downwards from one side and fits among them horizontally the element (2) as a strap with corrugated profile. For all that it is placed along the second direction, perpendicular to the elements (1) so that its depressions were opposite the elements (1). Then one moves up the elements (2) to the other side of the elements (1). Then the ends of the elements (1) of the first direction are bended into opposite directions and analogously is placed the next element (2) as a strap with corrugated profile and then the cycle is repeated. The assembling is continued analogously according to the length of the elements (1).

In FIG. 5 the profile of straps (1) and (2) is shown which is used in the described example as elements of construction.

In FIG. 6 the general view of given wicker construction is shown.

So far as the elements of construction which are used in the declared method of making wicker constructions are made of materials which are produced industrially and can be produced according to well-known industrial technologies, the declared method can be applied in the wood-processing industry, furniture and pieces of interior making. Received with its help wicker constructions will be of great application in interior decoration of buildings, as heating radiators screens, light partitions, wall and ceiling panels and also as furniture elements and door panels.

The production run of wicker constructions is made by the author the products of which are being under testing operation.

### SOURCES OF INFORMATION

1. Tarasenko V. M. Constructing and making wicker furniture. M., Lesnaya Prom. 1989
2. Internet resource: www.abode.ru/comm/rattan.html
3. Internetresource: http//catalog.haefele.ru/c/757.html (or http//optstroi.ru/pletenka)
4. Internet resource: www.traditions.ru/articles/basemethods.htm
5. Khrulev V. N. Making the constructions of wood and plastic. M., Vysshaya shkola, 1989
6. Shumega S. S. Illustrated aid on producing the carpenter-furniture products. M., 1991
7. Nanazashvili I. Kh. Construction materials and products. Reference book. Page 266. M., Adelant, 2005

1-5. (canceled)

6. A method for making a wicker construction comprising the steps of:
a) providing a first predetermined plurality of the elements pre-produced as straps with a straight profile;
b) providing a second predetermined plurality of the elements pre-produced as straps with a corrugated profile including a plurality of depressions and having a distance L between the depressions;
c) placing said elements of the first plurality substantially within a predetermined plane, along a predetermined direction, in a row parallel to each other with an interval of L/2;
d) wickering said elements of the first plurality and the second plurality so that:
d1) said elements of the first plurality are bent taking turns substantially upward and downward from said plane,
d2) an element of the second plurality is fitted between the elements of the first plurality at a predetermined angle to said direction and placed, so that said elements of the first plurality are set into the depressions of said elements of the second plurality; and
e) repeating steps (d1) and (d2) for each element of the second plurality thereby producing the wicker construction.

7. The method according to claim 6, wherein said elements of the second plurality are pre-produced of corrugated plywood, said plywood is sawed into straps.

8. The method according to claim 6, wherein said elements of the second plurality are pre-produced of wooden veneer sheets, the sheets of wooden veneer are bent and simultaneously glued together into corrugated wooden material and then are sawed into straps.

9. The method according to claim 6, wherein said elements of the second plurality are pre-produced of a wooden billet, the wooden billet is milled to acquire a corrugated profile and then is sawed into straps.

10. The method according to claim 6, wherein said predetermined angle is the right angle.

11. A method for making a wicker construction comprising the steps of:
a) providing a first predetermined plurality of elements pre-produced as straps with a corrugated profile including a plurality of depressions and a plurality of humps and having a distance L between said depressions and between said humps;
b) providing a second predetermined plurality of elements produced as straps with a corrugated profile including a plurality of depressions and a plurality of humps and having a distance L between said depressions and between said humps;
c) placing said elements of the first plurality substantially within a predetermined plane, along a predetermined direction, in a row parallel with each other with an interval of L/2, so that each depression of any of said elements of the first plurality is adjacent to a hump of the neighboring element of the first plurality;
d) wickering said elements of the first plurality and the second plurality so that:
d1) said elements of the first plurality are bent taking turns substantially upward and downward from said plane,
d2) an element of the second plurality is fitted between the elements of the first plurality at a predetermined angle to said direction and placed into the depressions of said elements of the first plurality, whereas the elements of the first plurality are placed into the depression of said element of the second plurality;
and
e) repeating steps (d1) and (d2) for each element of the second plurality thereby producing the wicker construction.

12. The method according to claim 11, wherein said elements of the first plurality and second plurality are pre-produced of corrugated plywood, said plywood is sawed into straps.

13. The method according to claim 11, wherein said elements of the first plurality and the second plurality are pre-produced of wooden veneer sheets, the sheets of wooden veneer are bent and simultaneously glued together into corrugated wooden material and then are sawed into straps.

14. The method according to claim 11, wherein said elements of the first plurality and the second plurality are pre-produced of a wooden billet, the wooden billet is milled to acquire a corrugated profile and then is sawed into straps.

15. The method according to claim 11, wherein said predetermined angle is the right angle.

16. A wicker construction comprising:
a first predetermined plurality of the elements pre-produced as straps with a straight profile;
a second predetermined plurality of the elements pre-produced as straps with a corrugated profile including a plurality of depressions and having a distance L between the depressions;
wherein
said elements of the first plurality are placed in a row parallel with each other with an interval of L/2; and
said elements of the first plurality and the second plurality are wickered so that said elements of the first plurality are placed into the depressions of said elements of the second plurality.

17. The wicker construction according to claim 16, wherein said elements of the second plurality are pre-produced of corrugated plywood, said plywood is sawed into straps.

18. The wicker construction according to claim 16, wherein said elements of the second plurality are pre-produced of wooden veneer sheets, the sheets of wooden veneer are bent and simultaneously glued together into corrugated wooden material and then are sawed into straps.

19. The wicker construction according to claim 16, wherein said elements of the second plurality are pre-produced of a wooden billet, the wooden billet is milled to acquire a corrugated profile and then is sawed into straps.

20. A wicker construction comprising:
a first predetermined plurality of elements pre-produced as straps with a corrugated profile including a plurality of depressions and a plurality of humps and having a distance L between said depressions and between said humps;
a second predetermined plurality of elements pre-produced as straps with a corrugated profile including a plurality of depressions and a plurality of humps and having a distance L between said depressions and between said humps;
wherein
said elements of the first plurality are placed in a row parallel with each other with an interval of L/2, so that each depression of any of said elements of the first plurality is adjacent to a hump of the neighboring element of the first plurality; and
said elements of the first plurality and the second plurality are wickered so that said elements of the first plurality are placed into the depressions of said elements of the second plurality, and said elements of the second plurality are placed into the depressions of said elements of the first plurality.

21. The wicker construction according to claim 20, wherein said elements of the first plurality and of the second plurality are pre-produced of corrugated plywood, said plywood is sawed into straps.

22. The wicker construction according to claim 20, wherein said elements of the first plurality and the second plurality are pre-produced of wooden veneer sheets, the sheets of wooden veneer are bent and simultaneously glued together into corrugated wooden material and then are sawed into straps.

23. The wicker construction according to claim 20, wherein said elements of the first plurality and the second plurality are pre-produced of a wooden billet, the wooden billet is milled to acquire a corrugated profile and then is sawed into straps.
